(19) United States
(12) Patent Application Publication
(10) Pub. No.: US 2007/0020513 A1
(43) Pub. Date: Jan. 25, 2007

(54) Energy Storage Cell Support Separator and Cooling System for a Multiple Cell Module

(75) Inventors: Alfonso O. Medina, San Diego, CA (US); Kevin T. Stone, San Diego, CA (US); Michael D. Wilk, Temecula, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 11/535,433

(22) Filed: Sep. 26, 2006

Related U.S. Application Data
(63) Continuation-in-part of application No. 11/459,754, filed on Jul. 25, 2006.
(63) Continuation-in-part of application No. 10/951,671, filed on Sep. 28, 2004.
(63) Continuation-in-part of application No. 10/720,916, filed on Nov. 24, 2003, now Pat. No. 7,085,112.
(63) Continuation-in-part of application No. 09/972,085, filed on Oct. 4, 2001, now Pat. No. 6,714,391.

(51) Int. Cl. H01M 10/50

(52) U.S. Cl. 429/120; 429/149

(57) ABSTRACT

A system for mounting and cooling energy storage cell canisters within a multi-cell energy storage module includes a plurality of inner interconnections to electrically connect the energy storage cell canisters end-to-end in strings of energy storage cell canisters; a plurality of bus bar interconnections to electrically connect the strings of energy storage cell canisters; and a plurality of cooling line separator inserts to position and support the plurality of inner interconnections for positioning and supporting the storage cell canisters.

### RELATED APPLICATIONS

This patent application is a continuation-in-part application of U.S. patent application Ser. No. 11/459,754 filed Jul. 25, 2006, which is a continuation-in-part application of U.S. patent application Ser. No. 10/951,671 filed Sep. 28, 2004, which is a continuation-in-part application of U.S. patent application Ser. No. 10/720,916 filed Nov. 24, 2003, which is a continuation-in-part application of U.S. patent application Ser. No. 09/972,085 filed Oct. 4, 2001, now U.S. Pat. No. 6,714,391. This application claims the benefit of these prior applications and these applications are incorporated by reference herein as though set forth in full.

### FIELD OF THE INVENTION

The field of the invention relates to the mounting and the support of energy storage cell canisters within a multi-cell energy storage module.

### BACKGROUND OF THE INVENTION

A multi-cell energy storage module (e.g., ultracapacitor module) may include a plurality of energy storage cell canisters (e.g., ultracapacitors) electrically connected together in series, physically end-to-end, to form a higher-voltage module. The cylindrical energy storage cell canisters may be electrically connected by means of rectangular bus bar interconnections with holes at each end to fit over circular end terminals of two energy storage cell canisters. A problem that has occurred in some of these multi-cell modules is that the energy storage cell canisters were not adequately supported relative to each other (i.e., not precisely fixed relative to each other). As a result, relative movement of the energy storage cell canisters caused the bus bar interconnections to flex. Over time, the flexing bus bar interconnection compromises the interconnection integrity, resulting in a high interconnection resistance. The high resistance lowers the efficiency of the energy storage and causes excessive heat generation that can destroy or shorten the life of the energy storage cell canisters. Similarly, excessive heat generated by inner interconnections between energy storage cell canisters lowers the efficiency of the energy storage and destroy or shorten the life of the energy storage cell canisters.

### SUMMARY OF THE INVENTION

Accordingly, an aspect of the present invention involves a system and a method to support and maintain a precision location of each energy storage cell canister within a multi-cell energy storage module, and to cool the energy storage cell canisters and interconnections therebetween.

Another aspect of the invention involves a system for mounting and cooling energy storage cell canisters within a multi-cell energy storage module. The system includes a plurality of inner interconnections to electrically connect the energy storage cell canisters end-to-end in strings of energy storage cell canisters; a plurality of bus bar interconnections to electrically connect the strings of energy storage cell canisters; and a plurality of cooling line separator inserts to position and support the plurality of inner interconnections for positioning and supporting the storage cell canisters, the plurality of cooling line separator inserts including fluid transfer lines for carrying cooling media therethrough for removing heat from the plurality of inner interconnections.

A further aspect of the invention involves a multi-cell energy storage module including a plurality of energy storage cell canisters; and a system for mounting and cooling the energy storage cell canisters having multiple fluid transfer lines for carrying cooling media therethrough for removing heat from the plurality of energy storage cell canisters.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1A is a front elevational view of an embodiment of a first separator insert of a multi-cell energy storage module;

FIG. 1B is a front elevational view of an embodiment of a second separator insert of a multi-cell energy storage module;

FIG. 2A is a perspective view of the first separator insert illustrated in FIG. 1A;

FIG. 2B is a perspective view of the second separator insert illustrated in FIG. 1B;

FIG. 3A is a front elevational view of an embodiment of a multi-cell energy storage module with the front of the multi-cell energy storage module removed;

FIG. 3B is rear elevational view of the multi-cell energy storage module of FIG. 3A with the rear of the multi-cell energy storage module removed;

FIG. 4A is a perspective view of an alternative embodiment of a separator insert of a multi-cell energy storage module;

FIG. 4B is a front elevational view of an alternative embodiment of a multi-cell energy storage module with the front of the multi-cell energy storage module removed;

FIG. 5 is a perspective view of an ultracapacitor cell canister with positive and negative male threaded terminals;

FIG. 6A is a perspective with end and side plane views of an embodiment of an interior interconnection disc;

FIG. 6B is end and side plane views of an alternative embodiment of an interior interconnection disc;

FIG. 6C is end and side plane views of another alternative embodiment of an interior interconnection disc;

FIG. 7A is a side crossection view of an embodiment of an interior interconnection;

FIG. 7B is a side crossection view of an alternative embodiment of an interior connection;

FIG. 7C is a crossectional view of an embodiment of the end to end connection of an interior energy cell connection with interconnection discs and cooling line separator insert;

FIG. 8A is a side crossection view of an end interconnection of the positive terminal of an ultracapacitor cell canister;

FIG. 8B is a side crossection view of an end interconnection of the negative terminal of an ultracapacitor cell canister;

FIG. 9A is a perspective with end and side plane views of an embodiment of a cooling line separator insert.

FIG. 9B is a perspective with end and side plane views of an alternative embodiment of a cooling line separator insert.

FIG. 10 is a front elevational view of an embodiment of a multi-cell energy storage module and an energy storage cell support separator and cooling system, with the front of the multi-cell energy storage module removed;

FIG. 11 is a cross-sectional view of the multi-cell energy storage module and energy storage cell support separator and cooling system of FIG. 10 taken along lines 11-11 of FIG. 10;

FIG. 12 is a schematic of the multi-cell energy storage module and energy storage cell support separator and cooling system of FIGS. 10 and 11;

FIG. 13 illustrates alternative embodiments of end connecting bus bars.

### DETAILED DESCRIPTION OF A PREFERRED EMBODIMENT

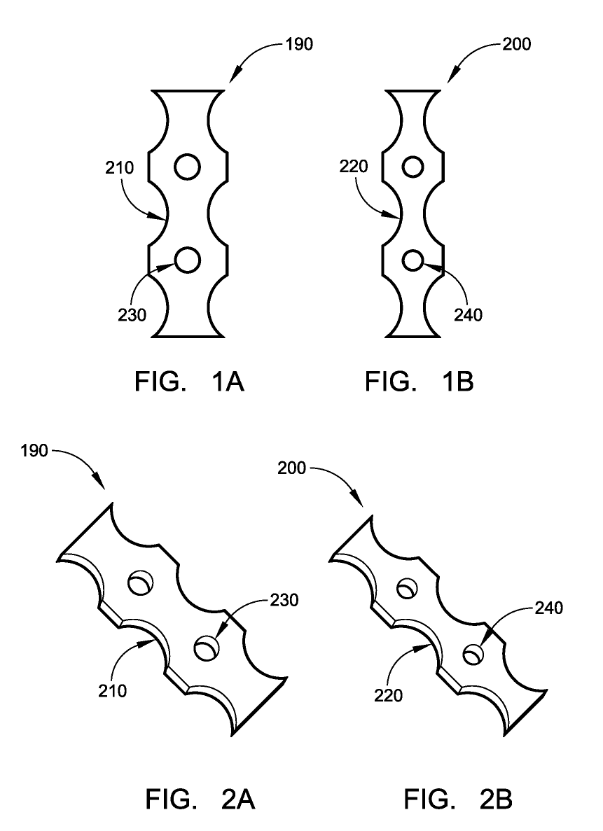

With reference to FIGS. 1-5, an embodiment of an energy storage cell support separator system 100 for a multiple-cell energy storage module 110 and method of using the same will be described.

In the embodiment shown, the multiple-cell energy storage module 110 is a Maxwell MC BMOD Energy Series 48V BOOSTCAP® brand Ultracapacitor Module made from Maxwell BOOSTCAP® brand ultracapacitor energy storage cell canisters. The module 110 includes eighteen (18) cylindrical energy storage cell canisters (i.e., cells, cans) 120 arranged in three rows of six energy storage cell canisters 120. In alternative embodiments, the invention is applied to other multiple-cell energy storage modules.

The energy storage cell canisters 120 are aluminum cylindrical cans approximately 2.27 inches in diameter and 6 inches in length with terminals 130 protruding from each end of the energy storage cell canister 120 for the electrical terminal connection. The ultracapacitor energy storage cell canister 120 is polarized with the negative side terminal 132 connected to the body 133 of the energy storage cell canister 120 and the positive side terminal 131 insulated 135 from the body 133 of the energy storage cell canister 120. In an alternative configuration of the energy storage cell canister 120, the terminals 130 are female threaded holes wherein male threaded studs are screwed into the holes to provide the protruding connection terminal.

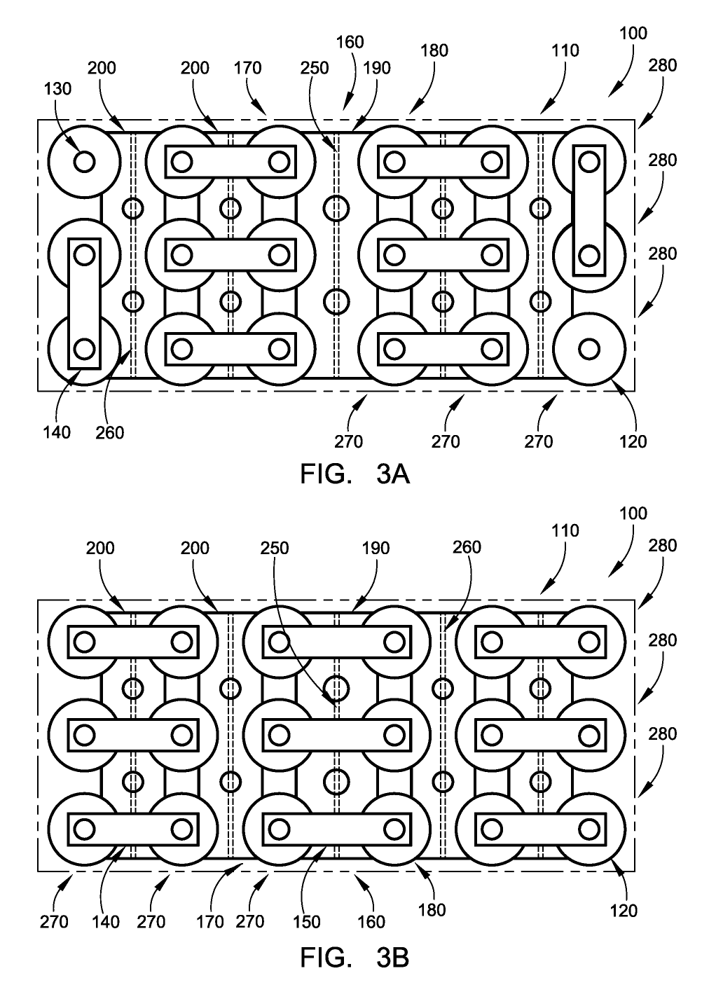

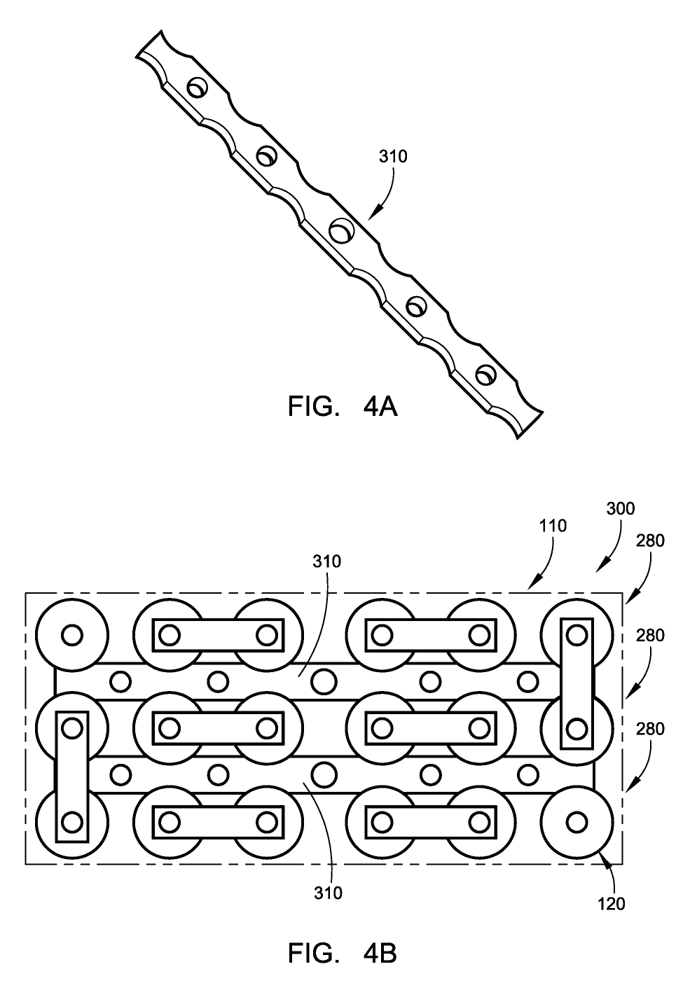

The energy storage cell canisters 120 are electrically connected by means of thin, rectangular bus bar interconnections 140, 150 with 0.54 inch diameter holes at each end to fit over the circular end terminals 130 of two energy storage cell canisters 120. Because the energy storage cell canisters 120 are spaced wider apart in a center 160 of the module 100, the bus bar interconnections 150 connecting across two middle columns 170, 180 of energy storage cell canisters 120 are 2.85 inches long whereas the other bus bar interconnections 140 are only 2.44 inches long. Other embodiments may have connection and separation patterns that differ from those shown in FIGS. 3-4.

During the assembly process the bus bar interconnections are heated to expand the holes, placed over the energy storage cell canister terminals, and allowed to cool for a shrunken press fit. The exterior 133 of the energy storage cell canister 120 is electrically active, being connected to the negative side 132 of the energy storage cell canister 120.

Separator inserts 190, 200 are made of high-temperature, ⅝-inch thick, electrically insulating nylon plastic. The separator inserts 190, 200 include incurved lateral sections 210, 220, which are machined into the nylon separator inserts 190, 200, to match the outer curved exterior of the energy storage cell canisters 120. The location of the incurved lateral sections 210, 220 are determined by the desired position of the energy storage cell canisters 120 within the module 110. Holes 230, 240 are drilled into the separator inserts 190, 200 to provide for wiring access to circuit boards 250, 260 (FIGS. 3A, 3B) located between front and rear separator inserts 190, 200 in the module 110. The size and location of the holes 230, 240 are determined by the wire feed-through requirements and the structural integrity of the separator inserts 190, 200. In the embodiment shown, the diameters of the energy storage cell canisters 120 and the vertical spacing of the energy storage cell canisters 120 are constant through the module 110. In alternative embodiments, the separator inserts 190, 200 are shaped to accommodate alternative energy storage cell canister configurations and spacing. In further embodiments, the separator inserts 190, 200 do not have holes, or have holes with different sizes, configurations, and/or positions that those shown.

Two three-can separator inserts 190, 200 are installed substantially perpendicular to the cylindrical axis of the energy storage cell canisters near the ends of the energy storage cell canisters (front, back of the module 110) in the five spaces between the six columns 270 of energy storage cell canisters 120, for a total of 10 separator inserts. As shown in FIGS. 1A, 1B 2A, 2B, separator insert 190 is wider than separator insert 200 to accommodate the extra width in the space at the center 160 of the module 110 between two middle columns 170, 180 of energy storage cell canisters 120.

With reference to FIGS. 4A and 4B, an alternative embodiment of an energy storage cell support separator system 300 is shown. In this embodiment, two six-can separator inserts 310 are installed substantially perpendicular to the cylindrical axis of the energy storage cell canisters 120 near the ends of the energy storage cell canisters 120 (front, back of the module 110) in the two spaces between the three rows 280 of energy storage cell canisters 120, for a total of four separator inserts.

In a further embodiment, the module 110 includes a mounting sheet or mounting plate that includes cut outs and/or holes to support and position the energy storage cell canisters 120 within the sealed module 110.

In the embodiment shown in FIG. 3, five balancing circuit printed circuit boards 250, 260, one for each space between energy storage cell canister columns 270, fit between the front, back separator inserts 190, 200. The printed circuit boards 250, 260 also have insulated separator inserts to position the circuit boards 250, 260 between the energy storage cell canisters 120 of adjacent columns 270. Insulated wires from the circuit boards 250, 260 pass through holes 230, 240 in the separator inserts 190, 200 and are riveted to the bus bar interconnections 140, 150 to form the connections required for the balancing circuits. The circuit boards 250, 260 add to the structural rigidity of the separator inserts 190, 200 to further help prevent the energy storage cell canisters 120 from moving and putting stress on the bus bar interconnections 140, 150 and end terminals 130. The circuit boards 250, 260 are held in place horizontally by the separator inserts 190, 200 on the ends and by insulated pads (not shown) on the circuit boards 250, 260 located between the circuit boards 250, 260 and the storage cell canisters 120. The circuit boards 250, 260 are held in place vertically by the module outside enclosure. In an alternate embodiment, grooves are cut in the nylon separator inserts 190, 200 to position and support the circuit boards 250, 260.

The circuit boards 250, 260 contain equalization and balancing circuits for the energy storage cell canisters 120 connected in series within the module 110. In an alternative embodiment, one or more of the circuit boards 250, 260 also contain communication circuits that report the module status external to the module 110. To connect the balancing circuits to the end terminals 130 of the energy storage cell canisters 120 wires pass through the holes 230, 240 in the separator inserts 190, 200 and are riveted to the bus bar interconnections 140, 150 through predrilled holes, not shown.

A method of manufacturing a multi-cell energy storage module 110 and/or retrofitting an existing multi-cell energy storage module 110 includes, first, shaping the separator inserts 190, 200 from ⅝-inch thick nylon plastic separator inserts. Each nylon plastic block is machined to the proper dimensions to fit the energy storage cell canisters 120 and their position within the module 110. Next, the electrical balancing and equalization circuits and circuit boards 250, 260 are manufactured. The nylon separator inserts 190, 200, supports for the circuit boards 250, 260, and the circuit boards 250, 260 are placed in the spaces between the columns 270 inside the module 110. During the installation of the circuit boards 250, 260, the wires from the circuit boards 250, 260 are fed through the holes 230, 240 in the nylon separator inserts 190, 200 and riveted to the interconnection bars 140, 150. In alternative embodiments, materials other than hard nylon plastic are used and/or other methods of forming the material to the desired shape are used.

The separator inserts 190, 200 rigidly support the energy storage cell canisters 120 in exact cell position relative to each other. A rigid and exact cell position is necessary to maintain the integrity and low electrical resistance of interconnecting bus bar interconnections 140, 150. Also, consistent spacing has to be maintained for active balance circuit printed circuit boards (PCBs) to fit properly between the energy storage cell canisters 120.

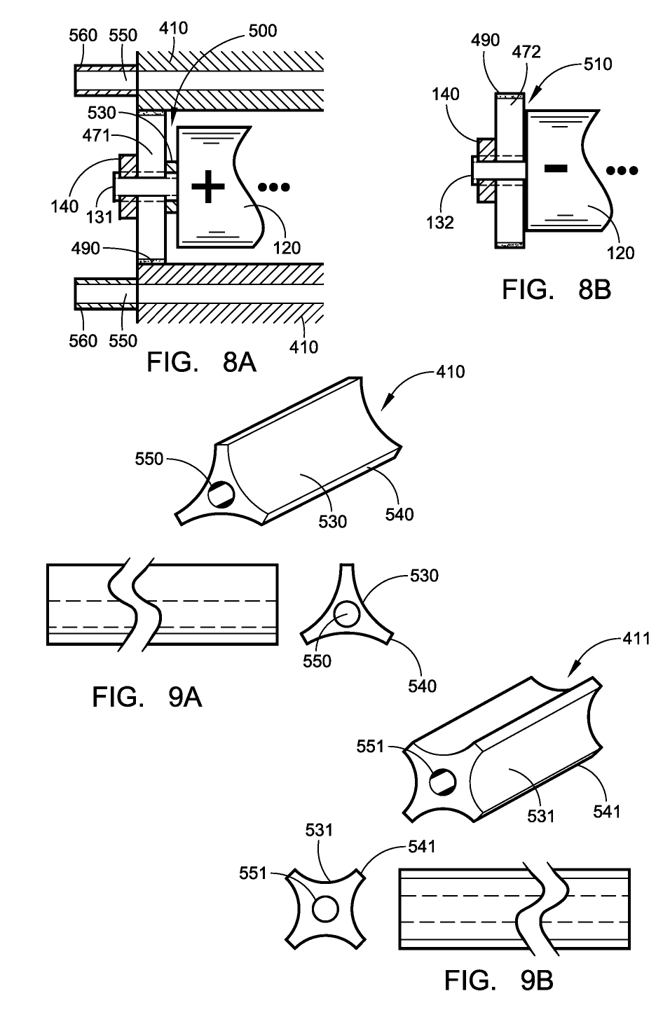

With reference to FIGS. 6-13, an embodiment of a multi-cell energy storage module 390 and an energy storage cell support separator and cooling system (hereinafter “support and cooling system”) 400 for a multiple-cell energy storage module 390 will be described. The multiple-cell energy storage module 390 includes rows of energy storage cell canisters 120. In each row, the energy storage cell canisters 120 are connected end to end with inner interconnection discs (also referred to herein as “interior interconnection discs”, or “inner interconnections”) 470 (FIGS. 6-8), and at the end of the rows the rows are connected together with bus bar interconnects 140 or outer interconnects, which are described above with respect to FIGS. 3A, 3B and FIGS. 8A, 8B.

Like elements of the multiple-cell energy storage module 390 and of the multiple-cell energy storage module 110 described above will be described below with the same reference numbers.

Although the multi-cell energy storage module 390 is shown as being rectangular, in alternative embodiments, the support and cooling system”) 400 is applied to any pack topographic configuration (e.g., flat, rectangular, cylindrical, rectilinear, curvilinear).

Referring to FIG. 6A, an interconnection disc 470 screws onto the positive and negative end terminals 131, 132 of two connecting energy storage cell canisters 120 to provide electrical connection, thermal connection, and structural support. In the embodiment shown, the disc 470 has a threaded hole 485 in the center and screws onto the male threaded terminals 131, 132 of the two canisters. For alternative embodiments, where either or both of the canister positive and negative terminals 131, 132 are female threaded holes, the interconnection disc 470 has a male threaded stud inserted or permanent protruding from the center to match the female threaded terminal holes. The disc 470 is made from aluminum to be electrically and thermally conductive and match the metal of the storage cell terminals 130.

The outer diameter 480 of the disc 470 is greater than the outer diameter of the cell canister 120 and is covered with a thin material 490 that is heat conducting, but electrically insulating material. Therefore, the cell canister 120 is electrically isolated and thermally connected to the cooling line separator support bars 410 through the interconnection discs 470.

Referencing FIGS. 6B and 6C, alternative embodiments 474, 478 may have different shapes, but maintain the diameter 480, the threaded center hole 485 and the electrically insulating and thermally conducting material 490. In alternative embodiments, the inner interconnects 470 are flat or have cut-outs and indentations to better match the requirements for insulation of the energy storage cell canisters 120, support structure, heat transfer, and assembly techniques.

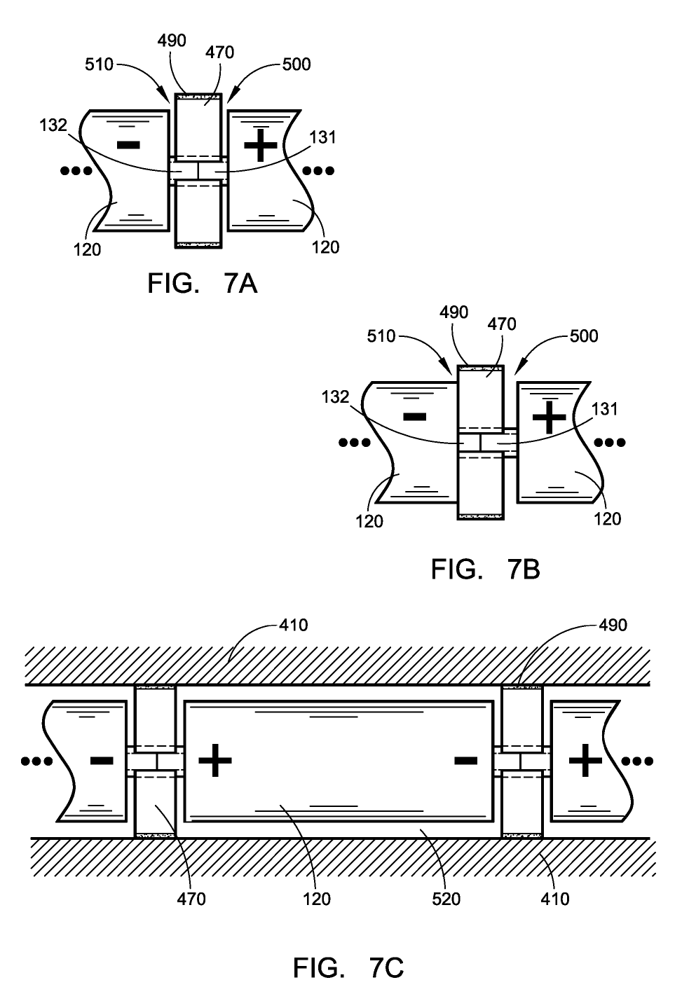

With reference to FIGS. 7A-7C, the disc 470 provides structural mounting support to the cell canister 120 through the cell canister terminals 131, 132 while separating the cell canister body 133 from the cooling line separator support bars 410 because of the larger outer diameter 480.

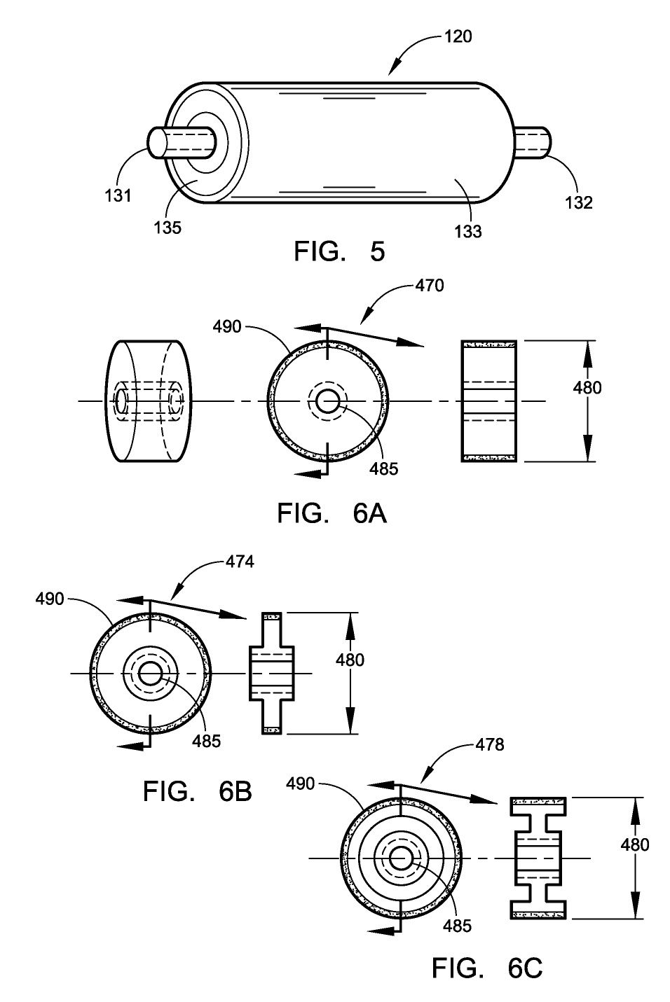

With reference to FIGS. 5 and 7A, the width of the disc 470 is narrow enough or has a cross sectional shape (FIGS. 6B, 6C) to maintain the air gaps 510, 500 to prevent shorting the disc 470 across the positive terminal 131 insulation 135 against the cell canister body 133. In an alternative embodiment a washer type of insulator is inserted between the interconnection disc 470 and the cell body 133 around the positive terminal 131 to main the air gap 500.

Referring to FIG. 7B, while maintaining an air gap 500 at the positive terminal 131 connection an alternative embodiment is to short 510 the disc 470 against the cell body 133 that is already electrically connected to the negative terminal 132. This alternative embodiment may have some advantage in the transfer of heat from the cell 120 to the cooling line separator support bar 410.

Referring to FIG. 7C, the heat generated inside the energy storage cell 120 flows into the interconnection disc 470 and thence, into the cooling line separator support bars 410. However, the energy storage cell is electrically isolated from the metal cooling line separator support bars because of the air gap 520 and the insulation material 490 on the outer diameter of the interconnection disc 470.

In the embodiment shown in FIG. 7C, the inner interconnects 470, rather than the bodies of the energy storage cell canisters 120, support the energy storage cell canister 120 against the cooling line separator inserts 410 for each row. Because the greatest part of the parasitic heat generated within an energy storage cell canister such as a ultracap can flows to the terminals rather than the can body, the inner interconnects 470 are heat sinks that transfer the heat to the cooling line separator inserts 410. This is especially important for the heat-generating energy storage cell canister interconnections within a row that have the farthest thermal travel to the point of cooling.

With reference to FIGS. 8A and 8B the end of row interconnection is now described. Similar to the inner interconnection, an interconnection disc 471 is screwed onto the positive end terminal 131 and an interconnection disc 472 is screwed onto the negative end terminal 132. The outside diameters of the interconnection discs 471, 472 are covered with a thin material 490 that thermally conducting, but electrically insulating. The discs 471, 472 may be the same as the inner interconnection disc 470 or may be thinner to accommodate the attachment of the interconnecting bus bar interconnections 140. The air gap 500 must be maintained at the positive terminal 131 of the cell 120 to prevent shorting the terminal 131 to the cell body 133. Insulator 530 may be inserted between the disc 471 and the cell 120 to maintain the air gap 500. The air gap 510 at the negative terminal is optional, but may be maintained with an insulator 530 if required as a spacer for the attachment of the end interconnection bus bar 140.

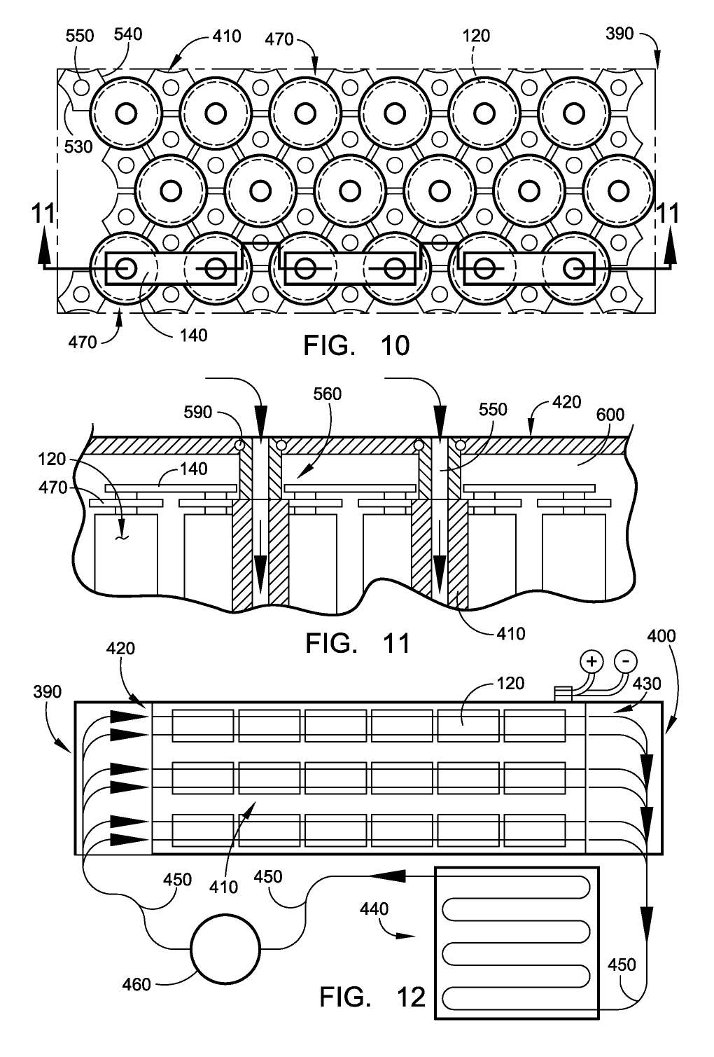

With reference to FIGS. 7C, 9A, 9B, the cooling line separator inserts 410 will be now be described in more detail. The cooling line separator inserts 410 are installed substantially parallel with the cylindrical axis of the energy storage cell canisters 120 (substantially parallel with the end-to-end strings of energy storage cell canisters 120). The cooling line separator inserts 410 form the support structure for the inner interconnects 470 for providing sufficient stiffness and securement in the assembly and strings of energy storage cell canisters 120 to prevent the interconnects from bending, deteriorating and causing increased internal resistance, and to prevent electrolyte leaking. Also, the cooling line separator inserts 410 remove heat from the inner interconnects 470, which provides an effective way to cool the entire associated energy storage cell canister(s) 120.

The cooling line separator support insert 410 is a longitudinally elongated aluminum extrusion and has a generally triangular cross-section. Each cooling line separator insert 410 includes three circumferentially spaced elongated concave sides 530 and elongated narrow flat faces 540 to form a substantially hexagonal, elongated configuration. The circumferentially spaced elongated concave sides 530 have a radius to conform to the outer surface 490 of the inner interconnections 470 to extract heat therefrom. The cooling line separator support insert 410 includes a fluid transfer cavity or line 550 for carrying cooling media therethrough for coolant flow and heat dissipation.

In alternative embodiments, the cooling line separator support inserts 410 are continuous along the entire row of energy storage cell canisters 120 and/or have a length to match the thickness of the end interconnection discs 471, 472 so as not to interfere with the bus bar connections. Because the cooling line separator inserts 410 do not extend beyond the interconnection discs 471, 472 there must be a coolant flow tube that structurally and thermally connects to the cooling line separator support inserts 410 and the outside end plate 420, 430.

In alternative embodiments, the cooling line separator support inserts 410 have various interior passage shapes for the coolant flow.

In other alternative embodiments the cooling line separator inserts 410 may have different shapes 411 (FIG. 9B) to match different packing configurations, different surfaces 531, 541 to match different energy storage cells 120, and different fluid transfer cavities to match heat dissipation requirements.

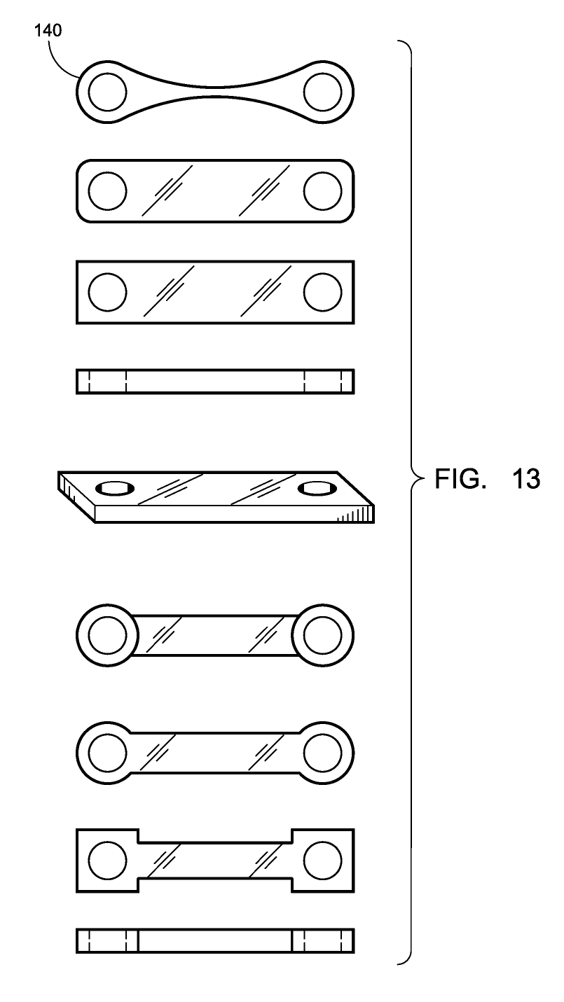

With reference to FIGS. 10, 11, 12, the system 400 (FIG. 12) transfers heat away from the interconnection discs 470 through the cooling line separator support inserts 410, and out of the multiple-cell energy storage module 390. Opposite ends of the cooling line separator support inserts 410 include threaded studs or port members 560 that the cooling media flows through. The cooling line separator support inserts 410 do not extend beyond the end interconnection discs 471, 472 (FIGS. 8A, 8B) to prevent interference and electrical shorts to the end interconnection bus bars 140. Covers/end plates 420, 430 connect to the ends of the cooling line separator inserts 410 at the port members 560. O-rings 590 are provided in receiving holes in the end plates 420, 430, around the port members 560 to seal the junction between the cooling line separator inserts 410 and the end plates 420, 430. In a space 600 between the ends of the energy storage cell canisters 120 and the end plates 420, 430, the bus bar interconnects 140 electrically interconnect energy storage cell canisters 120 at the ends of adjacent rows while the outer interconnection discs 471, 472 structurally support the cell canisters 120. FIG. 13 illustrates alternative embodiments of end connecting bus bars 140 to eliminate interference and electrical shorting to the port members 560. Alternatively and/or additionally, electrical insulation is used on the bus bars 140 and/or the port members 560. The interconnection discs 470 are connected to the terminal studs at the ends of adjacent rows of energy storage cell canisters 120, between the bus bar interconnects 140 and the ends of the energy storage cell canisters 120, to connect adjacent rows of energy storage cell canisters 120. In this manner, the interconnect 470 provides support and heat transfer to the cooling line separator inserts 410.

In the embodiment shown, each row of energy storage cell canisters 120 is surrounded by up to six cooling line separator inserts 410 that extend through the end plates 420, 430 to an external heat rejection/removal loop. The support and cooling system 400 includes cooling line separator inserts 410, an inlet end plate 420, an outlet end plate 430, a radiator 440, fluid transfer lines 450, and pump 460. The external heat removal loop includes the fluid transfer lines 450, the radiator 440, and the pump 460.

The multiple-cell energy storage module 390 is air-tight and water-tight to protect the terminal connections from shorting (in the event of a submersion) and gradual corrosion from moisture or other chemicals that may be present in the cooling flow. Additionally, toxic gases released during any fault condition that would cause cell leakage or rupture are totally contained within the multiple-cell energy storage module 390.

Optionally, any of the embodiments include a paste or gel on the threaded connections to aid in electrical and thermal conductance, and/or aid in resistance to corrosion of the connection and loosening of the connection.

Some of the advantages of the support and cooling system 300 include the formation of a support structure that provides sufficient stiffness and securement in the assembly and for the strings of energy storage cell canisters 120 to prevent the interconnects from bending, deteriorating and causing increased internal resistance, and to prevent electrolyte leaking. Also, the support and cooling system 300 removes heat from the inner interconnects 470, providing an effective way to cool the entire associated energy storage cell canister(s) 120. The system 400 transfer heat away from the interconnection discs 470 through the cooling line separator support inserts 410, and out of the multiple-cell energy storage module 390 through the external heat rejection/removal loop.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A system for mounting and cooling energy storage cell canisters within a multi-cell energy storage module, comprising:
a plurality of inner interconnections to electrically connect the energy storage cell canisters end-to-end in strings of energy storage cell canisters;
a plurality of bus bar interconnections to electrically connect the strings of energy storage cell canisters; and
a plurality of cooling line separator inserts to position and support the plurality of inner interconnections for positioning and supporting the storage cell canisters, the plurality of cooling line separator inserts including fluid transfer lines for carrying cooling media therethrough for removing heat from the plurality of inner interconnections.

2. The system of claim 1, wherein the energy storage cell canisters have a central longitudinal axis, and the plurality of cooling line separator inserts extend substantially parallel relative to central longitudinal axis of the energy storage cell canisters.

3. The system of claim 1, wherein the plurality of cooling line separator inserts are extruded aluminum.

4. The system of claim 1, wherein the energy storage cell canisters have an outer surface, and the plurality of shaped separator inserts are shaped to match and receive the outer surface of the plurality of inner interconnections.

5. The system of claim 1, wherein the plurality of shaped separator inserts include a generally triangular cross-section.

6. The system of claim 1, wherein the plurality of shaped separator inserts include an elongated, substantially hexagonal configuration.

7. The system of claim 1, wherein the energy storage cell canisters are ultracapacitors.

8. The system of claim 1, wherein the energy storage cell canisters are batteries.

9. The system of claim 1, wherein the energy storage cell canisters are shaped as a cylinder.

10. The system of claim 1, wherein the energy storage cell canisters are shaped as square cans.

11. The system of claim 1, wherein the plurality of shaped separator inserts contact the outer surface of the plurality of inner interconnections, but do not contact the energy storage cell canisters.

12. The system of claim 1, wherein the plurality of inner interconnections have a disc shape.

13. The system of claim 1, wherein the plurality of inner interconnections include an outer periphery with a heat-conductive, electrically insulative material thereon.

14. The system of claim 1, wherein the energy storage cell canisters include end terminals, and the plurality of inner interconnections connect the end terminals of the energy storage cell canisters for connecting the energy storage cell canisters end-to-end in strings of energy storage cell canisters.

15. The system of claim 14, wherein the energy storage cell canisters include a diameter, and the plurality of inner interconnections include cylindrical discs with a diameter slightly larger than the diameter of the energy storage cell canisters.

16. The system of claim 14, wherein the inner interconnects includes discs with one or more holes therein to receive the end terminals of the energy storage cell canisters.

17. A multi-cell energy storage module, comprising:
a plurality of energy storage cell canisters; and
a system for mounting and cooling the energy storage cell canisters including multiple fluid transfer lines for carrying cooling media therethrough for removing heat from the plurality of energy storage cell canisters.

18. The multi-cell energy storage module of claim 17, further including a plurality of inner interconnections to electrically connect the energy storage cell canisters end-to-end in strings of energy storage cell canisters, and the system for mounting and cooling the energy storage cell canisters position and support the plurality of inner interconnections without contact with the energy storage cell canisters for positioning and supporting the storage cell canisters in the multi-cell energy storage module.

19. The multi-cell energy storage module of claim 18, wherein the plurality of interconnections include at least one of a liquid, paste, or gel grease to at least one of enhance the electrical and thermal conductivity, and to protect against corrosion and thread connection loosening.

20. The system of claim 1, wherein the plurality of interconnections include at least one of a liquid, paste, or gel grease to at least one of enhance the electrical and thermal conductivity, and to protect against corrosion and thread connection loosening.

21. A system for mounting, positioning, and separating energy storage cell canisters within a multi-cell energy storage module comprising:
a plurality of bus bar interconnections to electrically connect the energy storage cell canisters;
a plurality of vertical or horizontal insulating separator inserts shaped to match the shape of the energy storage cell canisters and rigidly support the energy storage cell canisters in exact cell position relative to each other;
a module outside enclosure; and
an assembly of the energy storage cell canisters, separator inserts installed near the ends of the energy storage cell canisters, and bus bar interconnections within the module outside enclosure.

22. The system of claim 21, wherein the separator inserts are made of high-temperature, electrically insulating nylon plastic.

23. The system of claim 21, wherein the separator inserts have holes to provide wiring access to internal circuit boards.

24. The system of claim 21, wherein the separator inserts have slots to support and position internal circuit boards.

25. The system of claim 21, wherein the bus bar interconnections are heated to expand the holes, placed over the energy storage cell canister terminals, and allowed to cool for a shrunken press fit.

26. The system of claim 21, wherein the multiple-cell energy storage module is a Maxwell MC BMOD Energy Series 48V BOOSTCAP® brand Utracapacitor Module made from Maxwell BOOSTCAP® brand ultracapacitor energy storage cell canisters.

27. The system of claim 21, wherein the separator inserts are different sizes to accommodate different canister spacing.

28. The system of claim 21, wherein the bus bar connections are different sizes to accommodate different canister spacing.

29. The system of claim 21, wherein the assembly includes inside printed circuit boards.

30. The system of claim 29, wherein the printed circuit boards perform one or more of equalization and balancing circuits for the energy storage cell canisters connected in series within the module, and communication circuits for reporting status external to the module.

31. The system of claim 29, wherein the printed circuit boards have insulated pads to position and insulate the circuit board between the energy storage cell canisters.

32. The system of claim 30, wherein wires from equalization and balancing circuits extend from the printed circuit boards, pass through holes in the separators and are one of riveted, screwed, soldered, and welded to the bus bar interconnections.
